(19) United States
(12) Patent Application Publication
(10) Pub. No.: US 2007/0135562 A1
(43) Pub. Date: Jun. 14, 2007

(54) Modelling material and its use

(75) Inventors: Yvette Freese, Regensburg (DE); Ingrid Reutter, Nurnberg (DE); Heinrich Schnorrer, Schwandorf (DE)

Correspondence Address: Friedrich Kueffner, Suite 910, 317 Madison Avenue, New York, NY, 10017, US

(73) Assignee: J. S. Staedtler GmbH & Co.

(21) Appl. No.: 11/373,252

(22) Filed: Mar. 11, 2006

(30) Foreign Application Priority Data
Dec. 8, 2005 (DE) 10 2005 059 143.4

(51) Int. Cl. C08F 214/06

(52) U.S. Cl. 524/567

(57) ABSTRACT

A modelling material contains a binder in the form of a plastisol, wherein the plastisol contains essentially PVC (polyvinyl chloride) and at least one phthalate-free plasticizer. The phthalate-free plasticizer is citric acid-based, adipic acid-based, or benzoate ester-based. The material contains 5% by weight to 95% by weight PVC; 5% by weight to 30% by weight phthalate-free plasticizer; 0% by weight to 10% by weight stabilizer; 0% by weight to 10% by weight co-stabilizer; 0% by weight to 75% by weight fillers; 0% by weight to 5% by weight coloring agent; and 0% by weight to 5% by weight other additives.

### BACKGROUND OF THE INVENTION

1. Field of the Invention

The invention relates to an oven-bake modelling material and its use.

2. Description of the Related Art

Plastic oven-bake materials for shaping and sculpting objects are generally known.

The term modelling materials is to be understood also to concern so-called clays or polymer clays in the case of polymer-containing materials.

German patent 25 15 757 C3 discloses a plastic, hand-sculptable material that can be cured (hardened) by heat. Such material is comprised essentially of polyvinyl chloride, fillers, and plasticizers. A disadvantage of such materials is that they cure only at very high temperatures and the curing process is very slow. Moreover, the breaking strength of such curable materials is unsatisfactory. Also, it is a disadvantage that such materials contain up to 30% by weight of phthalate-containing plasticizers that are under suspicion of having a damaging effect on hormones or reproductive health.

Phthalate-containing plasticizers are added to synthetic materials (plastics) that are to be imparted with elastic properties in more or less high concentrations up to 40% by weight. They act as so-called external plasticizers because they do not form a chemical bond with the synthetic material. Because of the lack of a chemical bond, the phthalate can be dissolved relatively easily out of the synthetic material or can migrate slowly out of the synthetic material.

### SUMMARY OF THE INVENTION

It is an object of the present invention to provide a modelling or sculpting material that, while having a plasticizer content as low as possible, no longer has the aforementioned disadvantages and cures or hardens in particular at low temperatures and has excellent breaking strength in the cured state.

Another object of the invention is to provide a modelling material that is free as much as possible of materials that present a health hazard and/or are harmful to humans.

In accordance with the present invention, this is achieved in that the modelling material is comprised of a binder, present in the form of a plastisol, and optionally further additives, wherein the plastisol essentially is comprised of PVC and plasticizers, wherein the material contains at least one plasticizer that is free of phthalate.

The present invention is also directed to the use of the material of the present invention that is plastic, sculptable by hand, and curable by heating, as a modelling material for use by children and for producing arts and crafts objects and/or industrial objects and the objects produced therefrom, for example, candle holders, seal impressions, and jewelry.

The present invention is also directed to things and objects produced from a modelling material of the present invention wherein the modelling material after sculpting for designing the things and objects has been cured by heating.

The special advantages of the materials according to the invention reside in the easy manual processability of the modelling material. The consistency of the modelling material or clay at normal ambient temperature is constant in approximation; the modelling material does not cure at the recommended storage conditions (cool, dry, without direct exposure to sun) even at storage periods of several months, up to 48 months.

The modelling material (modelling clay) according to the invention is comprised of a binder that is present as a plastisol and optionally comprised of further additives, wherein the plastisol essentially is comprised of PVC and plasticizer and wherein the material or clay comprises at least one phthalate-free plasticizer.

The employed binder is comprised essentially of plastisol. This plastisol is comprised essentially of PVC (polyvinyl chloride) and plasticizer. In this connection, the PVC, inter alia, is an emulsion PVC that contains emulsifiers or is free of emulsifiers, suspension PVC and micropearl suspension PVC or a mixture of the individual PVC types.

The phthalate-free plasticizer is based on citric acid, adipic acid, and/or benzoate-ester. The phthalate-free plasticizer is, for example, acetyl tributyl citrate, tri-(2-ethylhexyl) acetyl citrate, trioctyl citrate, tridecyl citrate, tributyl citrate, trihexyl citrate, triethyl citrate, dioctyl adipate, diisodecyl adipate, diisononyl adipate, bis-(2-ethylhexyl) adipate, 1,2-cyclohexane dicarboxylic acid diisononyl ester, acetic acid ester of mono glycerides, benzoates, or a mixture of at least two of these substances. Moreover, the plasticizer can belong to the group of benzoate or benzoate esters. As examples, 2,2,4-triethyl-1,3-pentanediyl dibenzoates and their derivatives, triethylene glycol dibenzoates, diethylene glycol dibenzoates, diethylene glycol mono benzoates and/or propylene glycol dibenzoates are to be mentioned in this connection. Any mixture of the aforementioned plasticizers is possible.

The material contains 5-30% by weight of the phthalate-free plasticizer, preferably 10-28% of the phthalate-free plasticizer, particularly preferred 15-24% of the phthalate-free plasticizer.

An especially preferred embodiment of the invention is a material which is free of phthalate-free plasticizers.

A stabilizer improves the PVC stability, i.e., it prevents, inter alia, the cleavage of hydrogen chloride. In this connection, primarily inorganic and organic salts of the metals calcium, zinc, tin, magnesium, sodium, and potassium are used, for example, calcium stearate, sodium stearate, potassium stearate, zinc stearate, magnesium stearate, tin stearate and/or mixtures of the metal salts.

Co-stabilizers are also added to the material. One of the co-stabilizers added to the material is a fatty acid ester, preferably a long-chain fatty acid ester, having a chain length greater than C12. The fatty acid ester is comprised preferably of a straight-chain fatty acid and an alcohol. The alcohol is preferably a branched alcohol. As an example, octadecyl acid ester should be mentioned. The co-stabilizer improves the storage stability of the binder. Aging processes of the material can be prevented in this way.

It was found to be beneficial for improving the storage stability (shelf life) when the optionally present co-stabilizer is free of 2-ethylhexyl derivatives.

As further examples, epoxidized soybean oil, epoxidized oleic acid methyl ester, epoxidized linolic acid methyl ester, epoxidized linoleic acid methyl ester, epoxidized linoleic acid isopropyl ester, epoxidized rapeseed fatty acid methyl ester, epoxidized soybean fatty acid methyl ester, epoxidized linseed fatty acid methyl ester, or a mixture thereof should be mentioned.

As fillers, essentially inorganic and organic fillers are used, for example, kaolin, chalk, talcum, aluminum hydroxide and/or powdered clay; these fillers have a grain size of <250 μm, preferably smaller than 100 μm, and especially preferred <63 μm.

As further fillers, metal glitter, powdered glitter, and glitter flakes or mixtures of these substances can be present in order to obtain special visual effects.

Also, as fillers so-called light fillers can be used, or added to the aforementioned fillers. Examples of such light fillers are hollow spheres, in particular, hollow micro glass spheres, for example, produced by the company 3M or Osthoff Petrasch. Depending on the contents of the light fillers, the density can be adjusted as desired; it is advantageously in the range of 0.3 g/ml to 1.1 g/ml. The size of commercial light fillers can be selected freely wherein their size is preferably in a range of 10 μm to 400 μm.

Moreover, fillers based on polymers can be used; examples of this group of fillers are PAMA, PMMA (polymethyl methacrylate), and/or polyethylene.

As coloring agents, pigments in pure form, as pigment powders, as aqueous pigment preparations, preferably as azo-free pigments, special effect pigments, and/or azo-free lake pigments can be used. As a selection of numerous pigments that can be used the following are mentioned: pigment yellow 14 (C.I. 21095), pigment red 254 (C.I. 56110), pigment orange 34 (C.I. 21110), pigment red 122 (C.I. 73915), pigment green 7 (C.I. 74260), pigment white 6 (C.I. 77891), pigment black 7 (C.I. 77266), pigment red 101 (C.I. 77491), pigment violet 23 (C.I. 51319), pigment blue 29 (C.I. 77007), pigment yellow 185 (C.I. 56290), pigment yellow 1 (C.I. 11680), pigment red 48:2 (C.I. 15865:2), pigment red 53:1 (C.I. 15585:1), pigment orange 34 (C.I. 21115), pigment yellow 83 (C.I. 21108), and pigment blue 15 (C.I. 74160). By adding these coloring agents, a brilliant appearance is imparted to the material.

As further coloring agents, pearlescent pigments, mica, iron metal luster pigments, polyester glitter pigments, and luminescent pigments should be mentioned.

It should be mentioned in this context that differently colored modelling materials can also be combined, mixed, or kneaded freely with one another so that a marbling or mottling effect results.

Expediently, the employed coloring agents should no longer be water-soluble in the modelling material itself.

### DESCRIPTION OF THE PREFERRED EMBODIMENTS

The invention will be explained with the aid of a basic composition and a few exemplary formulations in more detail.

Basic Composition:
5-95% by weight PVC
5-30% by weight plasticizer, free of phthalate
0-10% by weight stabilizer
0-10% by weight co-stabilizer
0-75% filler
0-5% coloring agent
0-5% other additives

Stabilizers, co-stabilizers, coloring agents and fillers are examples of optionally employed additives. It should be noted in this context that also amounts up to 5% by weight of phthalate-containing plasticizers can be contained as an additive.

Formulation 1—No Coloring Agent:
65% by weight PVC or PVC copolymer
19% by weight plasticizer (adipic acid-based)
7% by weight stabilizer
19% by weight talcum

Formulation 2—Red Modelling Material
63% by weight PVC
24% by weight plasticizer (citric acid-based)
1% by weight stabilizers
7% by weight co-stabilizers
b 4% by weight filler
1% by weight pigment red 254

Formulation 3—Yellow Material
65% by weight PVC
21.5% by weight plasticizer (citric acid-based)
1.5% by weight co-stabilizer
5.5% by weight stabilizer
6.0% by weight filler (chalk, silica gel)
0.5% by weight pigment yellow 83

Prior Art—Ocher-Colored Comparative Formulation
15 kg emulsion PVC
17 kg suspension PVC
2.5 kg calcium stearate
13.5 kg di-n-octyl phthalate (plasticizer)
1 kg octyl fatty acid ester
14 kg aluminum silicate
0.5 kg pigments (ocher mixture).

The contents of plasticizer according to a preferred embodiment is between 10% by weight and 28% by weight and in an especially preferred embodiment between 15% by weight and 24% by weight.

The phthalate-free plasticizer of choice is citric acid-based and/or adipic acid-based.

The desired consistency of the material can be adjusted without problems by variation of the binder contents and/or plasticizer contents.

In comparison to the prior art, the material according to the invention has the following advantage: for the same hardening temperature of 130° C. the hardening time is significantly reduced. It is only 15 minutes instead of 30 minutes as before.

For the same curing time of 30 minutes the material cures already at the significantly lower temperature of 110° C. Also, the material can be cured already at less than 100° C. At 93° C. and a curing time of 40 minutes, the material is already cured.

In the following table the curing time of the material according to the invention is compared to the curing time of the material according to the prior art as a function of the temperature. It can be seen clearly that the curing time of the material according to the invention is 50% shorter than for the materials according to the prior art.

TABLE 1
Curing time as a function of the temperature

| | curing time at | curing time at |
|---|---|---|
| | 130° C. | 110° C. |
| material according to the | 15 min. | 30 min. |
| invention - formulation 2 | | |
| material according to the | 30 min. | 55 min. |
| prior art - comparative | | |
| formulation | | |

It was found that the oven-baked material according to the present invention in-comparison to the prior art has a significantly higher breaking strength, as can be seen in Table 2.

These higher breaking strengths have been determined and verified with a “Texture Analyzer” as well as according to the method of “Three Point Bending Rig”.

TABLE 2
Breaking strength of the cured material

| temperature in | breaking strength: | |
|---|---|---|
| the curing step, | material according | breaking strength: |
| curing time 30 | to the invention | material according |
| min. | [g] | to prior art [g] |
| 93° C. | 1.071 | not cured |
| 104° C. | 3.097 | 2.333 |
| 116° C. | 4.706 | 3.714 |
| 130° C. | 4.183 | 4.181 |

Moreover, by means of the “Texture Analyzer”, it was also determined that the cured material according to the present invention in comparison to the cured materials of the prior art had a significantly higher elasticity.

The manufacture of the materials according to the invention was carried out, for example, according to German patent 25 15 757 C3: the dry PVC powder is mixed with the fillers and, subsequently, the plasticizer and co-stabilizer are added. The material produced in this way is finished by kneading, optionally with cooling.

The material according to the invention is used in the manufacture of materials that are plastic, can be sculpted by hand, and cured by heating; as modelling materials (modelling clay) to be used by children; and for producing arts and crafts-type objects and/or industrial objects and the products produced from it, for example, candle holders, seal impressions, and jewelry.

The material or modelling clay can be further used for therapeutic purposes in the medical field, in order to exercise and rehabilitate haptic abilities.

Objects and things produced from the material according to the invention are cured or hardened after sculpting by being heated.

While specific embodiments of the invention have been shown and described in detail to illustrate the inventive principles, it will be understood that the invention may be embodied otherwise without departing from such principles.

What is claimed is:

1. A modelling material comprising:
a binder in the form of a plastisol, wherein the plastisol comprises PVC (polyvinyl chloride) and at least one phthalate-free plasticizer.

2. The material according to claim 1, comprising 5% by weight to 30% by weight of the at least one phthalate-free plasticizer.

3. The material according to claim 2, comprising 10% by weight to 28% by weight of the at least one phthalate-free plasticizer.

4. The material according to claim 3, comprising 15% by weight to 24% by weight of the at least one phthalate-free plasticizer.

5. The material according to claim 1, wherein the at least one phthalate-free plasticizer is selected from the group consisting of a citric acid-based plasticizer, an adipic acid-based plasticizer, and a benzoate ester-based plasticizer.

6. The material according to claim 5, wherein the at least one phthalate-free plasticizer is selected from the group consisting of acetyl tributyl citrate, tri-(2-ethylhexyl) acetyl citrate, trioctyl citrate, tridecyl citrate, tributyl citrate, trihexyl citrate, triethyl citrate, dioctyl adipate, diisodecyl adipate, diisononyl adipate, 1,2-cyclohexane dicarboxylic acid diisononyl ester, acetic acid ester of a mono glyceride, and benzoate.

7. The material according to claim 6, comprising a mixture of at least two of the plasticizers selected from the group consisting of acetyl tributyl citrate, tri-(2-ethylhexyl) acetyl citrate, trioctyl citrate, tridecyl citrate, tributyl citrate, trihexyl citrate, triethyl citrate, dioctyl adipate, diisodecyl adipate, diisononyl adipate, 1,2-cyclohexane dicarboxylic acid diisononyl ester, acetic acid ester of a mono glyceride, and benzoate.

8. The material according to claim 1, comprised of:
5% by weight to 95% by weight PVC;
5% by weight to 30% by weight phthalate-free plasticizer;
0% by weight to 10% by weight stabilizer;
0% by weight to 10% by weight co-stabilizer;
0% by weight to 75% by weight fillers;
0% by weight to 5% by weight coloring agent; and
0% by weight to 5% by weight other additives.

9. The material according to claim 1, further comprising a fatty acid ester as a co-stabilizer.

10. The material according to claim 9, wherein the fatty acid ester is a long-chain fatty acid ester having a chain length greater than C12.

11. The material according to claim 9, wherein the fatty acid ester is comprised of a straight-chain fatty acid and an alcohol.

12. The material according to claim 9, wherein the co-stabilizer comprises one or more of the substances selected from the group consisting of epoxidized soybean oil, epoxidized oleic acid methyl ester, epoxidized linolic acid methyl ester, epoxidized linoleic acid methyl ester, epoxidized linoleic acid isopropyl ester, epoxidized rapeseed fatty acid methyl ester, epoxidized soybean fatty acid methyl ester, and epoxidized linseed fatty acid methyl ester.

13. The material according to claim 1, further comprising a filler.

14. The material according to claim 13, wherein the filler is an inorganic filler.

15. The material according to claim 14, wherein the filler comprises one or more substances selected from the group consisting of kaolin, talcum, chalk, silica gel, powdered clay, and a light filler.

16. The material according to claim 1, further comprising a coloring agent.

17. The material according to claim 16, wherein the coloring agent is a pigment.

18. The material according to claim 17, wherein the pigment is selected from the group consisting of an azo-free pigment, a special effect pigment, and an azo-free lake pigment.

19. The material according to claim 1, wherein the material is free of phthalate-containing plasticizer.

20. The material according to claim 1, comprising a co-stabilizer that, for improving shelf life of the material, is free of 2-ethyl hexyl derivatives.

21. An object made from a modelling material according to claim 1, wherein, after sculpting the modelling material, the modelling material is cured by heating.
